(19) United States
(12) Patent Application Publication
(10) Pub. No.: US 2007/0251790 A1
(43) Pub. Date: Nov. 1, 2007

(54) Lockup Clutch for Hydrodynamic Components

(75) Inventors: Werner Klement, Heidenheim (DE); Werner Adams, Crailsheim (DE); Rolf Brockmann, Heidenheim (DE); Werner Koch, Deggingen (DE); Martin Becke, Ulm (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: VOITH TURBO GMBH & CO. KG.

(21) Appl. No.: 10/572,347

(22) PCT Filed: Sep. 20, 2004
(86) PCT No.: PCT/EP04/10521

§ 371 Date: Mar. 9, 2007

(30) Foreign Application Priority Data
Sep. 19, 2003 (DE) 103 43 971.4
Sep. 19, 2003 (DE) 103 43 906.4
Oct. 7, 2003 (DE) 103 47 037.9

(51) Int. Cl. F16D 33/00; F16H 47/06

(52) U.S. Cl. 192/3.29; 477/38

(57) ABSTRACT

The invention relates to a lockup clutch (1) for hydrodynamic components (2), comprising at least one primary wheel (4) and one secondary wheel (5), which define a working chamber (6), and having two inputs (26, 27)—a first input (26) linked to the secondary wheel (5) and a second input (27) linked to the primary wheel (4). Said inputs (26, 27) can be optionally linked to an output (28) of the lockup clutch (1) via a switchable clutch, thereby producing a first or a second power branch (32, 33). The coupling between the input (27) of the lockup clutch (1) that is coupled to the primary wheel (4) and the output (28) of the lockup clutch (1) in order to create the second power branch (33) is free of any rotationally fixed mechanical connection between the primary wheel (4) and the secondary wheel (5). The coupling between the inputs (26, 27) of the lockup clutch (1) and the output (28) of the lockup clutch (1) in the individual power branches (31, 33) is provided with rpm/torque converting devices.

The invention relates to a lockup clutch for hydrodynamic components, in particular for coupling with downstream gear steps of a gearbox, with the features in detail taken from the preamble of claim 1.

Hydrodynamic components, as starter components, are known in a plurality of designs for diverse types of gearbox. Common to all of them, however, is that, as a rule, they are effective, that is, they transmit power, only over a part of the entire operating range of the gearbox. Here, especially during the start-up operation, the advantageous properties of the hydrodynamic components, which can be designed in the form of hydrodynamic couplings or clutches or hydrodynamic rpm/torque converters, can be exploited. If the detrimental properties outweigh in comparison to mechanical power transmission, the hydrodynamic components become bridged or locked up; that is, the power flow no longer occurs via the hydrodynamic components. The bridging occurs here through a coupling of the secondary wheel to the primary wheel, preferably a rotationally fixed coupling, although designs subject to slip are also conceivable. As a rule, so-called lockup clutches, preferably constructed as multi-disc clutches, are used here for the bridging. The hydrodynamic component is no longer involved in the power transmission, but, on account of the fixed coupling, it is entrained along with it. When removed from the power flow, it can either remain filled, but is preferably emptied. As a rule, it is necessary here for the manufacturer of the hydrodynamic component to take into account the structural space for incorporating the lockup clutch. Furthermore, the manufacturer of the lockup clutch is constrained by the given specifications of the hydrodynamic component. Therefore, the entire element is delivered as a completely premounted, so-called starter unit. Because the lockup clutch involves, as a rule, a frictionally engaged clutch, losses in efficiency are registered. Furthermore, the component involved is subject to wear and, after a certain period of operation, it has to be replaced, and also, it has to be dimensioned in regard to the concrete mode of operation in order to regularly prevent overloads.

Gearbox structural units, in particular automatic gearboxes having a starter element as well as a lockup clutch associated with it and an rpm/torque converter unit downstream of the starter element and the lockup clutch, that are characterized by at least one gear step have been previously known in a plurality of designs. Reference in this regard is made, for example, to the following documents:

FR 2,719,355

DE 949,990

DE 972,489

U.S. Pat. No. 3,442,155

DE 960,529

Previously known from the document DE 949,990 is a gearbox for motor vehicles that has a power gearbox combined with a multispeed change spur gear having a main-shaft tie rod and, parallel to it, an auxiliary shaft tie rod, the primary wheel of the power gearbox being linked to the drive pinion of a toothed wheel back-gear unit, disposed upstream of the change gear-shift box, and the turbine wheel being linked to the drive pinion of an additional toothed wheel back-gear unit, upstream of the gear-shift box, wherein the gear ratio in the back gear that can be driven by the pump wheel is different from the gear ratio in the back gear that can be driven by the turbine wheel. Here, the turbine wheel is linked via a free wheel to the back gear coupled to it. The power transmission from the individual rpm/torque converting devices in the form of back gears then occurs via an additional back gear on the gearbox output, which is arranged coaxially to the gearbox input shaft. The hydrodynamic rpm/torque converter is always situated here in the power flow, which, however, especially in view of the main operating range of such a gearbox structural unit, has negative consequences in regard to efficiency and, furthermore, no possibility is afforded of thrust torque transmission to the drive engine on account of the intervening free wheel. The power transmission occurs via corresponding back gears, wherein corresponding gear steps are provided depending on the desired gear reductions and the desired power to be transmitted. Furthermore, in such a gearbox, the possible number of speeds is predetermined, so that any expansion leads to the incorporation of additional gear steps into the change gear. The consequence of this is that the axial length of the assembly is substantially increased. Other modifications that result in a change in the size of the assembly in the radial direction might be equally conceivable, but they are very costly.

The invention is therefore based on the problem of creating a possibility for bridging or locking up a hydrodynamic component, in particular a hydrodynamic clutch, which, on the one hand, is not constrained by the design specifications of the hydrodynamic component and, on the other hand, has advantageous properties in combination with at least one rpm/torque converting device, in particular individual gear steps. In so doing, it is to be ensured that there exists the possibility, in combination with downstream gearshift steps, of engaging, as needed, all gears either via the starter element or else by passing the starter element.

The solution in accordance with the invention is characterized by the features of claim 1. Advantageous embodiments are described in the subclaims.

In accordance with the invention, a lockup clutch is associated with the hydrodynamic component, comprising at least one primary wheel that can be coupled to and is preferably coupled to the drive and one secondary wheel that can be linked to at least one rpm/torque converting device, and said lockup clutch comprises at least two inputs and at least one output. Via the coupling between the individual input and the output, two power branches are created. To this end, a first input of the lockup clutch is linked to the secondary wheel in a rotationally fixed manner, whereas the second input is coupled to the primary wheel in a rotationally fixed manner. The first power branch is characterized here by the connection between the first input and the output and serves for power transmission via the hydrodynamic component. The second power branch is characterized by the coupling between the primary wheel and the output of the lockup clutch, the hydrodynamic component being bypassed in the power flow in this case. For optional coupling of the first or second power branch to the output or to the rpm/torque converting devices that can be coupled to the output, at least one switchable coupling device is provided. This comprises either a clutch that is associated with both power branches jointly and is characterized by at least two switching positions, whereby, in the first switching position, the first input is linked to the output at least indirectly in a rotationally fixed manner, whereas, in the second switching position, the second input is coupled to the output, the hydrodynamic component in this engaged position being free of a rotationally fixed coupling between the primary wheel and the secondary wheel. In detail, this means that the hydrodynamic component is taken out of the power flow and, for mechanical power transmission, at least the secondary wheel need no longer rotate as well, that is, is no longer necessarily coupled. Also conceivable is the association of a switchable coupling or clutch with each power branch; that is, the switchable coupling device comprises two clutches. Accordingly, the bridging of the hydrodynamic component itself occurs not only directly, but can also be performed at any point downstream of it in the power flow. This makes it also possible to locate the bridging in a gearbox when the hydrodynamic component is designed as a separate assembly unit.

For the realization of this functional mode, the lockup clutch comprises a first back gear linked to the secondary wheel in a rotationally fixed manner and a second back gear linked to the primary wheel in a rotationally fixed manner. The back gears can also be referred to as rpm/torque converting devices and serve to link shafts or other rotating elements that are arranged eccentrically with respect to one another. The two back gears can be linked optionally via the switchable coupling device to the output of the lockup clutch, said switchable coupling device comprising either one switchable clutch associated with the two back gears jointly or else two clutches, that is, clutches that are associated separately with each back gear and can be controlled separately or jointly. In the case of a coaxial arrangement of input and output of the lockup clutch or an eccentric arrangement with respect to the output of the two back gears, the connection is provided via an additional third back gear. Rpm- and torque-converting devices, which create various gear steps, can then be coupled to the output, it being also possible to utilize the back gear ratio of the third back gear as a gear step ratio. Preferably, in this case, the third back gear can be decoupled from the output via a second coupling device, comprising a single clutch. However, if the output of the lockup clutch is formed directly by the back-gear shaft coupled to the rpm/torque converting devices of the lockup clutch, it is possible to produce different gear steps via these devices or via the additional third back gear that can be linked to the back-gear shaft in a rotationally fixed manner. To this end, the switchable coupling device is arranged between the first and the second back gear either coaxially or in parallel or else eccentrically to a theoretical axis laid through the input of the combination consisting of the hydrodynamic component and the lockup clutch, the input of the combination being formed from the primary wheel or at least indirectly from the second input of the lockup clutch. The switchable clutch serves to couple a back-gear shaft, arranged parallel to the input, to the two back gears—the first back gear and the second back gear—and, via the back-gear shaft, to the downstream gear steps, the output of the lockup clutch either being formed directly by the back-gear shaft and the succeeding gear steps being created preferably by the additional third back gear that has a different gear ratio and can be coupled to the actual gearbox output or else the connection to the succeeding gear steps being still created via an additional gear ratio in the form of a third back gear that cannot be decoupled and is linked to the output in a rotationally fixed manner. In the first case, a plurality of third back gears that can be optionally coupled to the back-gear shaft are provided, as it were, and they create different gear ratios. In the other case, the third back gear serves for feedback onto an input shaft of a gearbox unit creating any gear steps—for example, a gearbox unit designed with planetary gears. When purely mechanical power transmission is desired, the lockup clutch makes it possible to bypass the hydrodynamic component, which is free of a rotationally fixed coupling between the primary wheel and the secondary wheel. In this case, the secondary wheel can be carried along freely in rotation and is free of any support with respect to a rotating or positionally fixed element. This can occur here when the hydrodynamic component is filled. The bridging, that is, the bypassing of the hydrodynamic power branch, occurs here through a change or switch of the power pathway or the two power pathways via the first or second back gear.

The first and the second back gears are arranged coaxially and parallel to each other. Depending on the arrangement of the primary wheel and the secondary wheel between² the input of the subassembly consisting of the lockup clutch and the hydrodynamic component and the output of the subassembly as viewed in the axial direction, the first and the second back gears are arranged here next to each other in the axial direction. The input of the subassembly is formed here by the primary wheel or by an element that is linked to it in a rotationally fixed manner or the first input of the lockup clutch. The output of the subassembly consisting of the hydrodynamic component and the lockup clutch is formed by the output of the lockup clutch. The latter serves for coupling with downstream rpm/torque converting devices. When the primary wheel is arranged in the axial direction in front of the secondary wheel, the first back gear is arranged in front of the second back gear. Other possibilities are conceivable. There exists a plurality of possibilities in regard to the design of the back gears. Preferably, these back gears are designed as simple spur gear sets. These spur gear sets each comprise two spur gears that intermesh with each other, a first spur gear being linked to the secondary wheel in a rotationally fixed manner or, for the second back gear, being linked to the primary wheel in a rotationally fixed manner, while the second spur gears that each intermesh with these wheels can be coupled via the first switchable clutch to the back-gear shaft in a rotationally fixed manner. This also applies to the third back gear that can be coupled to the back-gear shaft in a rotationally fixed manner and can be linked to or is linked to the output A in a rotationally fixed manner

The gear ratios of the first and second back gears are identical in the simplest case. When the switchable clutch is designed as a positive locking clutch, however, it is necessary for the rpms of the two outputs of the first and second back gears to be identical in order to create the bridging, so as to bring the switchable clutch or clutches of the first coupling device into the switching position that makes possible a rotationally fixed connection of the back gear to the back-gear shaft. To this end, as a rule, the rpm of the drive engine that can be coupled to the input consisting of the hydrodynamic component and the lockup clutch is reduced, preferably in a controlled manner. According to an especially advantageous embodiment, however, it is possible to dispense with such a control of the drive engine when the design of the two back gears, the first back gear and the second back gear, occurs in such a way that, for the second back gear, which is coupled to the primary wheel in a rotationally fixed manner, there is chosen a gear ratio that takes into account the slip of the hydrodynamic clutch. This is based on a specific predefined slip value, which is characterized by a specific predefined permissible rpm difference between the primary wheel and the secondary wheel. The second back gear is dimensioned in such a way that a specific rpm difference with respect to the secondary wheel and with respect to the first back gear that is coupled to it is compensated for in the case of this back gear by having the two outputs of the two back gears rotate at the same rpm, thus producing the requisite rpm equivalence, so as to switch the power flow pathway for synchronously switchable couplings. On account of the same rpm resulting from the different gear ratios at the outputs of the back gears, a switching between the first and second back gears can occur without any problem in this state. The dimensioning, in particular the design of the spur gears in terms of the number of teeth, the diameter, and the parameters determining the engagement is accordingly a function of a specific predefined difference in rpm at which a lockup is to occur.

Absolutely essential in order to create the lockup function is at least one switchable coupling device that is associated with the two power branches, comprising either a switchable clutch associated with the two back gears (first and second) jointly, which is arranged between the two back gears and optionally serves for the rotationally fixed coupling of the first back gear with the back-gear shaft or else of the second back gear with the back-gear shaft, or a clutch associated separately with each back gear. In the simplest case, a switchable clutch that can be used jointly in alternation is associated with the two back gears. It is also conceivable to associate with each of the back gears or power branches their own switchable clutch that can be controlled individually, wherein the actuation thereof, however, should be adapted to both of the back gears or power branches. Here, the clutches can be arranged coaxially to the starter element as well as eccentrically to it. The arrangement here can occur at any point in the power pathway of the individual power branches; that is, the arrangement can be coaxial as well as eccentric with respect to the back-gear shaft. Here, there also exists the theoretical possibility, with the association in each case of one switchable clutch with one power branch, of providing the arrangement at different positions in the two power branches.

The back gear additionally makes it possible to create a gear ratio with respect to the following gearbox input. This ratio is dependent on the value of the gear ratio in the back gears—in the first and second back gears and possibly in the third back gear. However, in order to create a direct rigid coupling between the input of the subassembly consisting of the hydrodynamic component and the lockup clutch and the output thereof, which can be coupled to the input of the following rpm/torque converting devices, an additional switchable clutch is further provided, which, in the case of the coupling of the input of downstream gearshift steps via the third back gear, links or does not link the third back gear optionally to the back-gear shaft, as well as a switchable clutch, which is arranged between the two back gears, coupled to the primary wheel and the secondary wheel, and the third back gear and which links these to one another in a functional state in a rotationally fixed manner. This clutch is referred to here as the third clutch. In the case where the third back gear is designed as a gear step ratio, that is, the output of the lockup clutch is formed from the back-gear shaft, the function of this additional third clutch for decoupling the third back gear is already assumed in each case by the clutches already associated with the individual third back gears, without anything further. The third clutch makes possible a direct rotationally fixed coupling between the inputs and the output of the lockup clutch, this coupling provided coaxially to the input and output of the subassembly or at least of the hydrodynamic component. The direct coupling occurs here preferably outside of the power branch. This arrangement makes it possible to create a through-drive between input and output of the subassembly consisting of the hydrodynamic component and the lockup clutch, it being possible in the case of coupling with succeeding gearbox steps to speak of a direct gear with a ratio of 1:1. The power flow occurs here directly between the input and the output coaxially and not via further transmitting elements. This switching position is chosen for the through-drive in direct gear, in which functional state the two clutches, the switchable clutch and the second switchable clutch, which create the connections between the inputs of the lockup clutch and the back-gear shaft and between the back-gear shaft and the output of the lockup clutch, are then opened in this functional state and accordingly the back-gear shaft is decoupled from the input or the output. Created in this case is a power transmission with optimal efficiency in direct through-drive. In order to be able to switch the third switchable clutch, there also occurs an equalization of the rpms between the input and the output, preferably through a reduction in the rpm of the drive engine.

In accordance with an especially advantageous embodiment, a braking device is further associated with the secondary wheel. This braking device can be constructed in a number of designs. It serves here for the braking or preferably the fixing in place of the secondary wheel, whereby, during mechanical power transmission, the hydrodynamic clutch, when it is filled, functions as a hydrodynamic retarder by having the output supported via the third and second back gears or else, in the case of direct coupling to the primary wheel, on the secondary wheel, functioning as a stator.

In accordance with the invention, preferably synchronously switchable, positive locking couplings are employed as switchable clutches so as to reduce wear, these clutches being constructed in turn preferably as claw clutches. Designs with force-activated clutches are equally conceivable.

For combination of the lockup clutch with the hydrodynamic component, the input and output of the subassembly thus formed are

a) arranged coaxially or

b) parallel to each other.

Preferably, for reasons of a simple and space-saving construction of the lockup clutch, the arrangement is made coaxially. The lockup clutch and the hydrodynamic component can be designed here as a structural unit or else as separate structural units. In the latter case, the lockup clutch can also be combined with rpm/torque converting devices downstream of it into a single structural unit. In this case, the construction of the hydrodynamic component is nearly independent of the gearbox comprising the rpm/torque converting devices.

Here, the hydrodynamic component can, as a hydrodynamic clutch, be designed to be free of a guide wheel or hydrodynamic rpm/torque converter. The latter additionally comprises at least one guide wheel.

According to an especially advantageous further development, when there is a desired bridging between the two outputs of the first and second back gears the rpm equivalence is provided during the dimensioning of the individual back gears through consideration of the slip, that is, especially of the difference in rpm between the primary wheel and the secondary wheel of the hydrodynamic component for the state in which a bridging is desired. To this end, a specific predefined slip value at the hydrodynamic component is taken as the basis; it can be chosen at will or else is characterized by the power characteristics of the hydrodynamic component (for example, approximately 20%) that would still permit optimal operation with respect to the efficiency, and it characterizes a specific predefined difference in rpm between the primary wheel and the secondary wheel. This difference in rpm is taken into account in designing the two back gears, so that it is taken into consideration at the outputs, in particular at the toothed gearwheels that can be coupled to the back-gear shaft that is arranged in parallel or eccentrically to the hydrodynamic component. The shaping of the individual intermeshing spur gears in terms of their dimensions as well as the number of teeth and/or tooth shape and design is provided here as a function of the rpm difference n_{P}-n_{T} between the primary wheel and the secondary wheel. In this way it is possible, in the case of power transmission via the first power branch, that is, in the case of a hydrodynamic power transmission when the specific slip value is adjusted at the hydrodynamic component, in particular the hydrodynamic clutch, to perform the lockup when this rpm difference exists, without any additional measures, by bringing the switchable clutch into a switching position that now links the second back gear, coupled to the primary wheel, to the back-gear shaft and thereby making possible a through-drive between the input of the lockup clutch, coupled to the primary wheel, or between the primary wheel and thus the drive engine coupled to it and the output of the lockup clutch via the back gear at least in part parallel to the axis of rotation of the hydrodynamic component.

The dimensioning, in particular the design of the individual spur gears in terms of the number of teeth, the diameter, and/or the parameters determining engagement is defined as a function of the difference in rpm at which a lockup will result. In regard to the concrete implementation, taking into consideration the slip in the gear ratios, difference possibilities are conceivable. For example, this can occur solely through a change in the distribution to the individual spur gears, their diameters remaining constant, in particular the outside diameter, the root diameter, or the mean diameter; in these cases, the tooth width is essentially varied. Another possibility consists in appropriately adapting and changing a majority and preferably all of the parameters that characterize the teeth of a spur gear. Preferably, however, the solutions chosen here are always marked by small structural modifications, in addition to an optimal efficiency, which make it possible to resort to standardized components. In detail, then, the rpm of the element that is coupled to the secondary wheel in a rotationally fixed manner and is to be linked via the switchable clutch to the output of the lockup clutch is reduced in the magnitude of the rpm difference compared to the rpm of the primary wheel or of the element that is coupled to it in a rotationally fixed manner and that is linked via the switchable clutch to the output.

The first and the second back gears are arranged coaxially and parallel to each other. Depending on the arrangement of the primary wheel and the secondary wheel between³ the input of the subassembly consisting of the lockup clutch and the hydrodynamic component and the output of it viewed in the axial direction, the first back gear and the second back gear are arranged next to each other in the axial direction. The input of the subassembly is formed here by the primary wheel or an element linked to it in a rotationally fixed manner or the first input of the lockup clutch. The output of the subassembly that can be formed from the hydrodynamic component and the lockup clutch is formed from the output of the lockup clutch. The latter serves for coupling to downstream rpm/torque converting devices. When the primary wheel is arranged in the axial direction in front of the secondary wheel, the first back gear is arranged in front of the second back gear. Other possibilities are conceivable. There exists a plurality of possibilities in regard to the design of the back gears. Preferably, these are designed as simple spur gear sets. They then each comprise two mutually intermeshing spur gears, a first spur gear being linked in each case to the secondary wheel in a rotationally fixed manner or, for the second back gear, to the primary wheel in a rotationally fixed manner, while the respective second spur gears intermeshing with these can be coupled to the back-gear shaft via the first switchable clutch in a rotationally fixed manner. This also applies to the third back gear that is coupled to the back-gear shaft in a rotationally fixed manner or preferably can be coupled to the back-gear shaft in a rotationally fixed manner and that can be linked to or is linked to the output A of the lockup clutch, again in a rotationally fixed manner, or to the individual back gears defining the gear steps of the downstream gearbox in the case when the output of the lockup clutch is created from the back-gear shaft.

According to an especially advantageous embodiment, a free wheel is provided between the secondary wheel and the back gears of the lockup clutch. This free wheel is further interposed after the connection of the braking device to the secondary wheel in the direction of power flow as viewed between the input and output of the starter element. It makes possible the realization of a hill-holder function and further enables, even when the hydrodynamic clutch is filled, the provision that it can be decoupled from the driveline in interaction with the braking device.

The solution in accordance with the invention will be illustrated below on the basis of figures.

Shown therein in detail are the following:

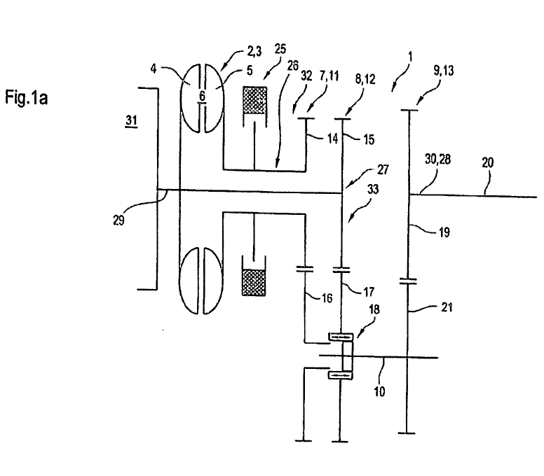

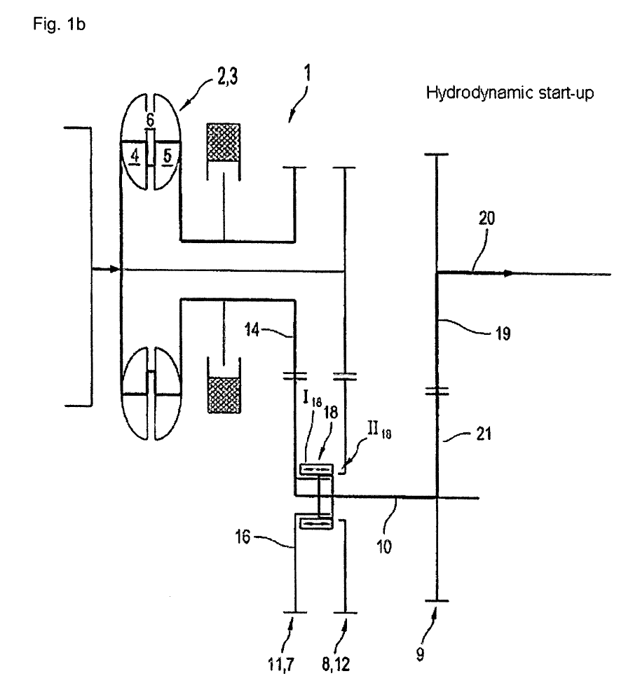

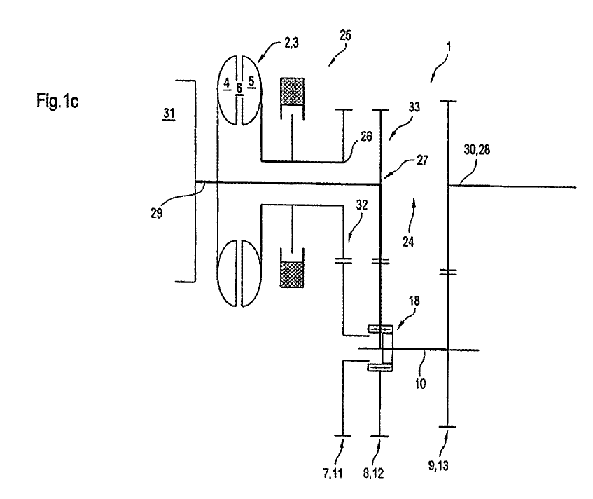

FIGS. 1a-1d illustrate, in a schematically simplified depiction, the basic principle and the basic construction of a lockup clutch designed in accordance with the invention through eccentric arrangement of the switching elements of the individual operating phases;

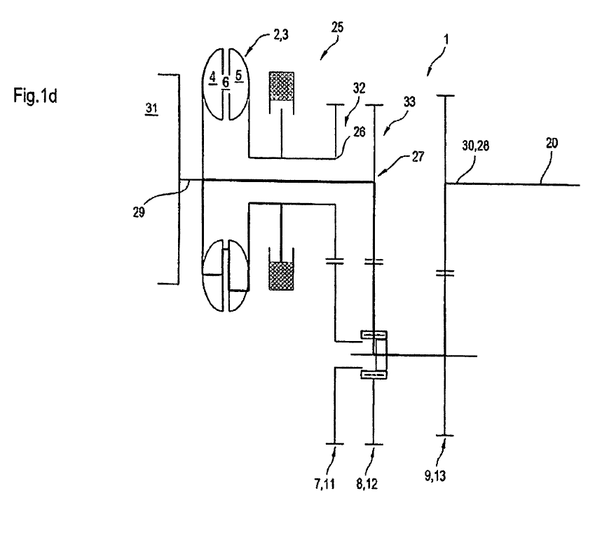

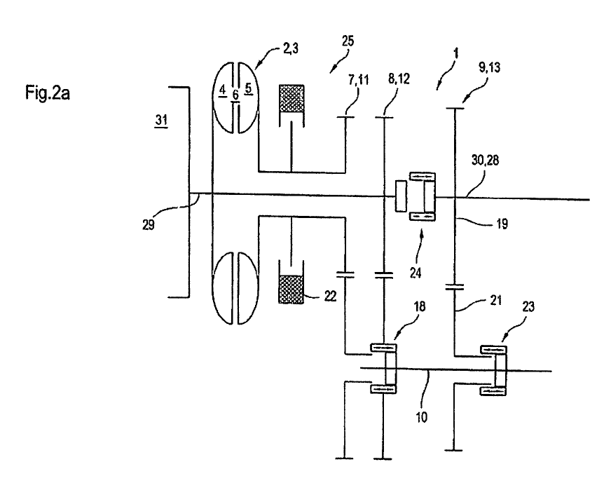

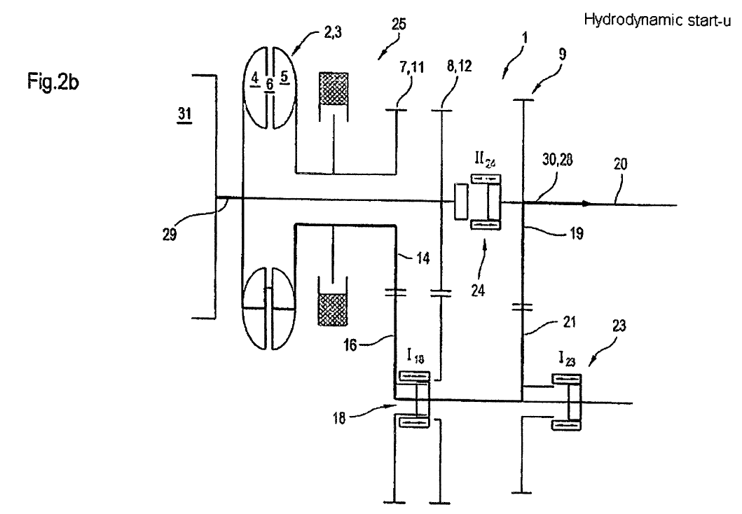

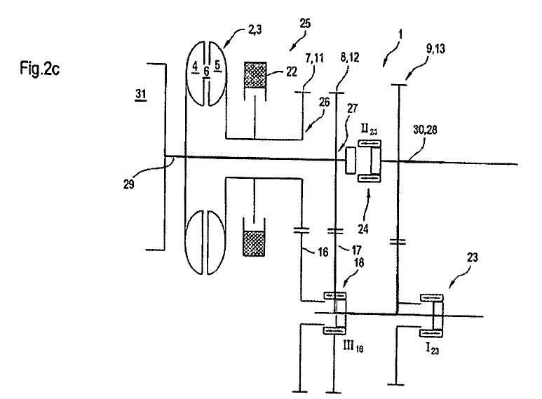

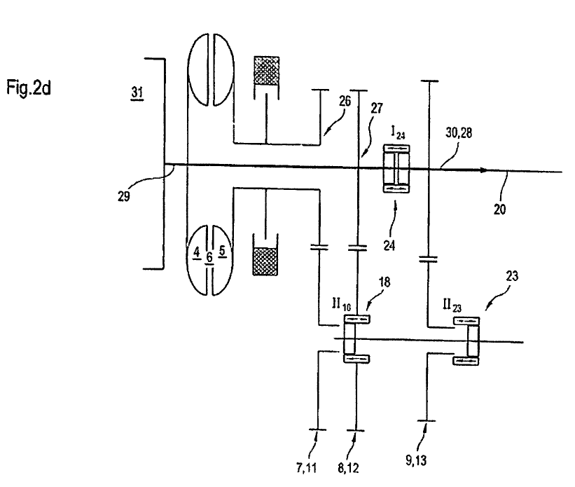

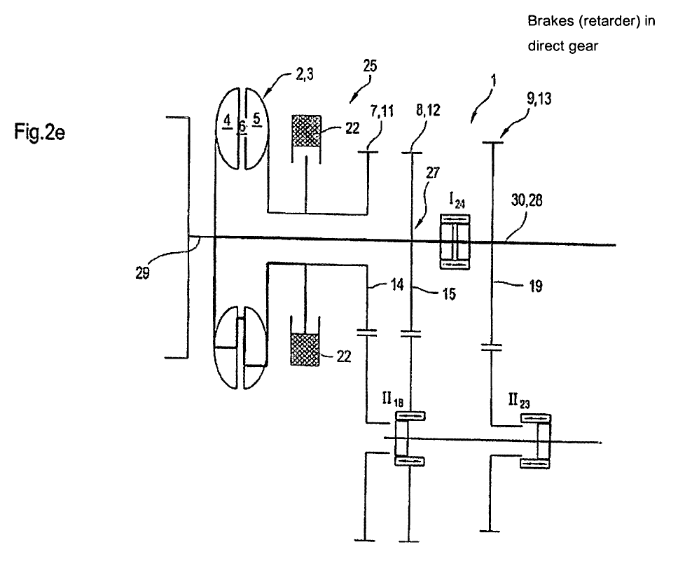

FIGS. 2a-2e illustrate, in a schematically simplified depiction based on an especially advantageous embodiment, a further development of the solution in accordance with the invention according to FIG. 1 in the individual operating phases;

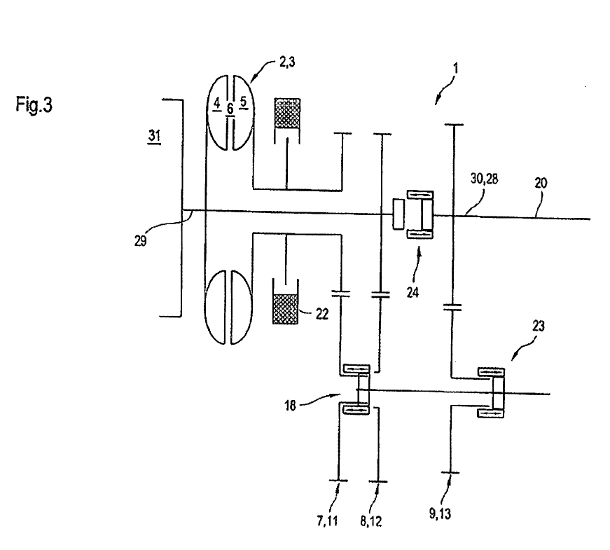

FIG. 3 illustrates an advantageous further development of an embodiment according to FIG. 2 that avoids an rpm adjustment of the drive engine that can be coupled to the input;

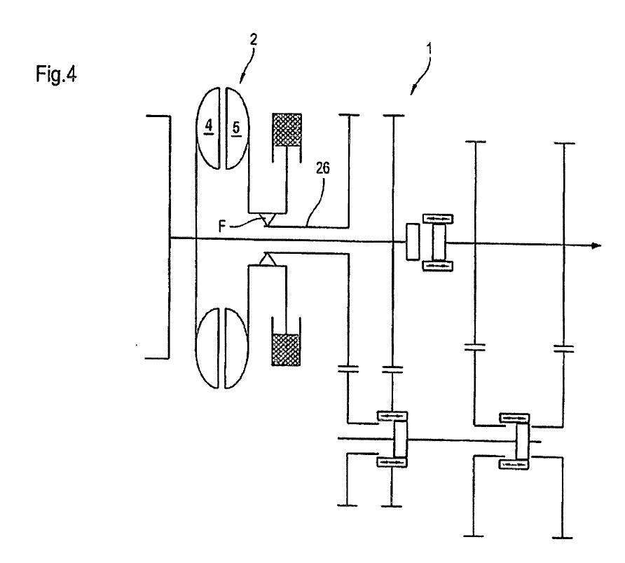

FIG. 4 illustrates an embodiment according to FIG. 1 with a free wheel.

FIG. 1a illustrates, in a schematically simplified depiction, the basic principle and the basic construction of a lockup clutch 1 designed in accordance with the invention, with which is associated a hydrodynamic component 2. In combination with each other, the two of them form a subassembly 25. Here, in the case depicted, the hydrodynamic component 2 is designed as a hydrodynamic clutch 3. Said clutch comprises at least one primary wheel 4, which can be linked at least indirectly in a rotationally fixed manner to a drive 31, which is indicated here, and one secondary wheel 5, which can be linked at least indirectly to an output drive in a rotationally fixed manner. Here, the primary wheel 4 forms an input 29 of the subassembly 25. The secondary wheel 5 can be linked at least indirectly to the output 30 of the subassembly 25. This coupling occurs via the lockup clutch 1. However, the output 29 and the input 30 are preferably not necessarily arranged coaxially. The primary wheel 4 and the secondary wheel 5 together define a working chamber 6 that can be filled with operating fluid. In accordance with the invention, the lockup clutch 1 comprises two inputs, a first input 26, which can be linked to the secondary wheel 5 at least directly⁴, that is, directly or via additional elements, in a rotationally fixed manner, and a second input 27, which is linked at least indirectly, that is, directly or via additional elements to the primary wheel 4 in a rotationally fixed manner. Further provided is an output 28, which forms the output of the subassembly 25. Here, each input 26 or 27 can be selectively linked to the output 28 via transmission elements. This results in the creation of two power branches, a first power branch 32 and a second power branch 33. The first power branch is characterized by the exclusive transmission of power via a hydrodynamic pathway. The second power pathway is characterized by a purely mechanical transmission of power. The coupling occurs selectively; that is, only one input is linked in each case to the output 28. To this end, the lockup clutch 1 comprises two back gears, a first back gear 7 and a second back gear 8. Here, the first back gear 7 is linked to the secondary wheel 5 in a rotationally fixed manner. The second back gear 8 is linked to the primary wheel 4 in a rotationally fixed manner. The connection occurs here at least indirectly, that is, either directly to the corresponding components or via additional elements that are coupled to it in a rotationally fixed manner. Further provided in accordance with the invention is a switchable clutch 18, which is arranged between the first back gear 7 and the second back gear 8 and makes possible the selective coupling between the first back gear 7 or the second back gear 8 and a back-gear shaft 10, coupled via a third back gear 9. Here, the individual back gears, the first back gear 7, the second back gear 8, and the third back gear 9, are preferably designed as spur gear sets. These are labeled as 11 for the first back gear 7, as 12 for the second back gear 8, and as 13 for the third back gear 9. The pinion gears 14 and 15 of the spur gear sets 11 and 12 of the first back gear 7 and of the second back gear 8 are here each linked to the primary wheel 4 or to the secondary wheel 5, respectively, as described, in a rotationally fixed manner. The spur gear 16 for the spur gear set 11 of the first back gear 7 and the spur gear 17 of the spur gear set 12 of the second back gear 8, which can be coupled to these, can be optionally linked via the switchable clutch 18 of the back-gear shaft 10. The switchable clutch 18 is arranged here parallel to the input 29 or to the primary wheel 4 or the secondary wheel 5. Here, the back-gear shaft 10 can be designed as a solid or hollow shaft. Said shaft is arranged parallel to a theoretical axis between the input 29 or the output 28 and the hydrodynamic clutch 3. Said clutch is linked to a spur gear 21 of the spur gear set 13 of the third back gear 9 in a rotationally fixed manner according to a first embodiment. The spur gear 21 of the third back gear 9 that intermeshes with this spur gear 19 is linked to the output 28, in particular to the shaft 20 formed by said output, in a rotationally fixed manner. Accordingly, in the case depicted, the switchable clutch 18, provided for bypassing the power flow via the hydrodynamic component 2, in particular the hydrodynamic clutch 3, is not arranged coaxially to the hydrodynamic clutch 3, but rather parallel or eccentrically to it. The power flow is switched between hydrodynamic power transmission and mechanical power transmission via the switchable clutch 18 by means of the two back gears—the first back gear 7 and the second back gear 8—with the power flow occurring, depending on the switching position of the switchable clutch 18, either via the first back gear 7 or via the second back gear 8 from the output 28 and, in both cases, being conveyed via the third back gear 9 to the output 28, which is arranged coaxially to the input 29. Another conceivable possibility, which, however, is not depicted here, consists of associating each power branch, that is, each back gear, with its own switchable clutch. Here, the arrangement is made coaxially or eccentrically to the starter element and can occur anywhere in the power pathway; that is, it can be associated with an element of the rpm/torque converting device forming the back gear. The lockup function, which is produced in conventional designs through the creation of a rotationally fixed coupling between the primary wheel 4 and the secondary wheel 5, is realized in accordance with the invention by the power flow via two pathways, this solution being free of a rotationally fixed connection between the primary wheel 4 and the secondary wheel 5. Here, in the start-up state, the switchable clutch 18 is in the functional position I₁₈, depicted in FIG. 1b, for which it creates a rotationally fixed connection between the spur gear 16 of the spur gear set 11 of the first back gear 7 and the back-gear shaft 10. The power flow then occurs, as viewed in traction operation, between the drive 31 and the output drive of the input 29 via the hydrodynamic component 2, which is filled with operating fluid in this functional state, in particular the hydrodynamic clutch 3, onto the pinion gear 14, coupled to the secondary wheel 5 in a rotationally fixed manner, of the first back gear 7, the spur gear 16 intermeshing with it onto the back-gear shaft 10, and, from it, onto the third back gear 9, in particular the spur gear 21 and the spur gear 19 coupled to the output 28 in a rotationally fixed manner, onto said spur gear, for example, the shaft 20 forming it or onto another element that is coupled with it in a rotationally fixed manner. The switchover occurs in purely mechanical operation by switching the clutch 18, in particular by providing the switching position II₁₈, in which the second back gear 8 is linked to the back-gear shaft 10 and thus to the third back gear 9 in a rotationally fixed manner. Here, the power flow also occurs, as viewed in traction operation, from the input 29 in the direction to the output 30 via the second back gear 8, which is coupled to the primary wheel 4 in a rotationally fixed manner, in particular the pinion gear 15, onto the spur gear 17, the back-gear shaft 10, the spur gear 19, 21 and, from this, onto the shaft that is coupled to it in a rotationally fixed manner or onto another element that is coupled to it in a rotationally fixed manner. This power flow is depicted in FIG. 1c. In this state, the hydrodynamic clutch is taken out of the power flow and only the primary wheel is 4 is entrained with it. The secondary wheel 5 is completely decoupled. The clutch 3 can therefore remain filled.

For the braking operation in accordance with FIG. 1d, the hydrodynamic component 2, in particular the hydrodynamic clutch 3, is utilized as a hydrodynamic retarder. To this end, a braking device 22 is associated with the secondary wheel 5 and can be designed in many ways. It serves for fixing in place the secondary wheel 5. This applies to the mechanical braking mode in accordance with FIG. 1c; that is, in this case, the power flow occurs from the output 28 or 30 via the third back gear 9 onto the second back gear 8 to the primary wheel 4, which, in this functional state, functions as a rotor. In this functional state, the secondary wheel 5 is designed as a stator. The output drive A thus supports itself via the two back gears, the third back gear 9 and the second back gear 8, as well as the primary wheel 4 linked to these in a rotationally fixed manner, on the stator, which is formed by the secondary wheel 5.

When the hydrodynamic clutch 3 is coupled to the lockup arrangement 1 with the gear steps of a gearbox, the power flow via the back gear, in particular the back gears 7, 8, and 9, makes possible a gear reduction in the individual gear steps. Although, depending on the design of the gear ratio in the back gears, different gear ratios can be taken into account, a poorer efficiency is to be expected here, as a rule, for the desired 1:1 gear ratio on account of the power transmission via the back gears 7, 8. In order to achieve a rigid coupling between the input 29 and the output 30 of the subassembly 25 or the primary wheel 4 or the input 27 of the lockup clutch 1 in this case, an additional third clutch 24 is arranged between the second and the third back gears 8 and 9 in accordance with the invention according to an especially advantageous embodiment in FIG. 2a and which can be switched and is arranged coaxially to the hydrodynamic clutch 3 as well as to the input 29 and the output 30 of the subassembly 25 or the inputs 26, 27 and the output 28 of the lockup clutch 1. Here, this third clutch 24 makes possible the direct mechanical through-drive from the input 29 to the output 30 or from the inputs 26, 27 to the output 28, free of being conveyed via additional rpm/torque converting devices. The rpm and the torque at the input 29 correspond here, when the clutch 24 is switched, to those at the output. In this embodiment, furthermore, an additional second switchable clutch 23 is provided for decoupling the third back gear 9 from the back-gear shaft 10. It serves for the optional coupling of the third back gear 9 to the back-gear shaft 10, in particular of the spur gear 21 to the shaft 10. In all of the embodiments described in FIGS. 1a to 1d as well as 2a, the switchable clutches, in particular the switchable clutch 18 as well as 23 and 24, are designed preferably as positive locking synchronously switchable couplings, preferably in the form of claw clutches. Other embodiments, in particular in the form of force-activated clutches, are equally conceivable. However, the latter operate with slip, which results in a reduction in the efficiency of the entire system. Therefore, in accordance with the invention, preferably positive locking, synchronously switchable couplings are put into use.

FIG. 2b illustrates, for the embodiment according to FIG. 2a, the power flow of the hydrodynamic component 2 during the start-up process, that is, in hydrodynamic operation. In this, the hydrodynamic component 2 is filled with operating fluid. The power flow occurs via the hydrodynamic component 2, in particular the hydrodynamic clutch 3. The first switchable clutch 18 is found in the switching position I₁₈; that is, it creates the rotationally fixed connection between the first back gear 7, in particular the spur gear 16, and the back-gear shaft 10. The second back gear 8 is decoupled from the back-gear shaft 10. The second clutch 23 also is found in this first switching position I₂₃, in which a rotationally fixed connection with the back-gear shaft is created. The third switchable clutch 24 is found in the second switching position II₂₄; that is, it is released or opened. Here, the power flow occurs from the input 29 via the primary wheel 4, the secondary wheel 5 onto the first back gear 7, in particular the pinion gear 14, the spur gear 16 onto the back-gear shaft 10, the third back gear 9, in particular the spur gear 21 as well as the spur gear 19, which is coupled to the shaft 20 in a rotationally fixed manner. The switchover or bridging of the hydrodynamic component 2, in particular the hydrodynamic clutch 3, is provided by switching the power pathway, in particular by switching the first switchable clutch 18, which is brought into the switching position III₁₈ according to FIG. 2c, which makes possible a rotationally fixed connection with the second back gear 8 and the back-gear shaft 10. Here, the first back gear 7 is decoupled from the back-gear shaft 10. The second clutch 23 remains in its first switching position I₂₃, that is, a rotationally fixed connection between the third back gear 9 and the back-gear shaft 10 is provided. Here, the switchover occurs by way of a specific reduction in the rpm at the input 29 or at the input 27 of the lockup clutch, in particular of the drive engine coupled to it in a rotationally fixed manner and of the slip-transmitting hydrodynamic clutch 3, in order to achieve an rpm equivalence between the spur gears 16 and 17 of the back gears 7 and 8. The power flow that ensues in the switching position III₁₈ of the first switchable clutch 18, which bypasses the hydrodynamic component 2, in particular the power flow resulting from the hydrodynamic clutch 3, is depicted in FIG. 2c. In this operating state, too, only the first and second clutches 18, 23 are actuated, whereas the third clutch 24 is opened in the switching position II₂₄. The power flow accordingly does not occur directly, but rather via the back gears 8 and 9 and thus parallel to the axis connecting the axis of rotation of the hydrodynamic component 2 and the output 28 of the lockup clutch 1.

By contrast, FIG. 2d illustrates the possible power transmission with a gear ratio of 1:1 between the input 29 and the output 30 of the subassembly 25 or the inputs 26, 27 of the lockup clutch 1 and the output 28 that is possible when the third clutch 24 is exploited. In it, the switchable clutch 24 is then closed; that is, it is found in the first switching position I₂₄, which links the input 27, in particular the second back gear 8, to the third back gear 9, in particular the pinion gear 15 to the spur gear 19, in a rotationally fixed manner. The first switchable clutch 18 and the second switchable clutch 23 are opened in this functional state; that is, they are found in the switching positions II₁₈ and II₂₃, respectively. The power transmission occurs here coaxially between input 29 and output 30 of the subassembly 25 free from the transmission via rpm/torque converting devices. The input 29 is coupled rigidly to the output 30.

In contrast to this, FIG. 2e illustrates the realization of the braking operation in so-called direct gear, that is, when the power transmission is from the input 29 to the output 30. Here, too, the third clutch 24 is closed, whereas the two other clutches 18 and 23 are opened and accordingly decouple the individual back gears, in particular the back gears 7, 8, and 9, from the outputs 30 and 28, respectively, of the lockup clutch 1. The outputs 30 and 28, respectively, and the rpm/torque converting devices linked to them support themselves in this functional state via the primary wheel 4 on the secondary wheel 5, which functions as a stator. The latter is fixed in place, preferably on a round part, by actuation of the braking device 22. Accordingly, it is possible to achieve a braking action in all mechanical gears and it is possible to realize this with the highest possible gear ratio on account of the direct through-drive.

For all embodiments and functional modes depicted in FIGS. 1 and 2, the same gear ratios were chosen for the first back gear 7 and the second back gear 8. According to an advantageous further development, however, it is also possible, as depicted in FIG. 3, based on an embodiment according to FIG. 2a, to perform a switching without rpm adjustment of the primary wheel 4 coupled directly to the input 29 or the input 27 and, at the same time, to achieve an improvement in the acceleration by way of a higher tractive power in the mechanical system. This is provided according to an especially advantageous embodiment by changing the back-gear gear ratio between the first back gear 7 and the second back gear 8 by the slip amount at which a lockup is desired. This means, in detail, that, while the gear ratio for the first back gear 7 is kept constant, the gear ratio at the second back gear 8 is reduced. To this end, in order to avoid an rpm adjustment of the primary wheel 4, which is coupled directly to the input 29 or to the input 27, the rpm difference at which a lockup is desired is compensated for by the design or dimensioning of the individual back gears, in particular the back gear 7, which is coupled to the secondary wheel in a rotationally fixed manner, and the back gear 8, which is coupled to the primary wheel 4 in a rotationally fixed manner. Here, the two back gears are designed with different gear ratios and the power transmission via the hydrodynamic component 2 is performed at a specific preselected rpm difference between the primary wheel 4 and the secondary wheel 5, which is reflected in an rpm equivalence at the outputs of the back gears 7 and 8, in particular in the rpms at the spur gears 16. This means that, in the state of power transmission with a predefined slip amount between the primary wheel 4 and the secondary wheel 5, that is, an rpm difference between the primary wheel 4 and the secondary wheel 5, a lockup on account of the rpm equivalence at the output of the individual back gears 7 and 8, in particular at the spur gears 16 and 17, which is due to the gear ratio, becomes possible. The design of the back gears 7 and 8 occurs in such a way that, on account of the lower rpm at the secondary wheel, in comparison to the primary wheel, which exists in the case of slip, the rpm of the element that is linked to the primary wheel 4 via the back gear 7 in a rotationally fixed manner, and which can be linked at least indirectly via the switchable clutch to the output 28 of the lockup clutch 1 in a rotationally fixed manner, is reduced or the rpm of the output of the first back gear, which is coupled to the secondary wheel, is increased. The corresponding gear ratio, as a function of the slip being compensated for, is chosen here in accordance with common knowledge. This is done through appropriate dimensioning of the toothed gears, the teeth, and the geometry of engagement. Here, it is possible, depending on the magnitude of the slip value being compensated for, that is, depending on the rpm difference being compensated for, either to influence only the distribution or else to influence the overall geometry, in particular the diameter and the number of teeth of the spur gears. The concrete measure to be taken here lies in the judgment of the competent practitioner. The slip amount, that is, the rpm difference at which lockup is to occur, is set or chosen here as a function of the properties of the hydrodynamic component. The hydrodynamic clutch 1 remains preferably at least partially filled. The functional mode is provided as described in FIGS. 1 and 2.

In all of the embodiments depicted in the figures, the power flow between input 29 and output 30 in traction operation has been depicted and described by way of example. Thrust operation, of course, is possible as well.

The solution in accordance with the invention is not limited to the embodiments depicted in FIGS. 1 to 3. Other embodiments are possible. FIGS. 1 to 3 represent merely basic variants and advantageous embodiments of the basic concept of the invention. It is only crucial that, through switchover between two power pathways, different functional modes can be realized, in which, in the functional state where the hydrodynamic component is bypassed, a mechanical power transmission results and is free from any direct rotationally fixed coupling between the primary wheel and the secondary wheel of the hydrodynamic component. When the two power branches are created, the flow of power does not occur directly coaxially, but rather parallel to the theoretical axis of rotation of the hydrodynamic structural element. As the hydrodynamic structural element here, hydrodynamic clutches or else hydrodynamic rpm/torque converters can find use.

FIGS. 1 to 4 illustrate constructions having a clutch associated with both back gears jointly and arranged coaxially to the back-gear shaft. Conceivable, however, is also the embodiment, which is not depicted, with association of a jointly useable coupling device coaxially to the starter element as well as constructions having two switchable clutches, which are each associated with one of the two back gears and can be arranged in any position in the power flow (coaxially to the starter element or to the back-gear shaft or else eccentrically to them). Finding use in an especially advantageous way as switchable couplings, as already discussed, are synchronously switchable, positive locking couplings. This means that it is possible to completely dispense with frictionally engaged coupling elements. The requisite rpm adjustments in order to create the switching operation are undertaken here via the control technology.

The lockup clutch designed in accordance with the invention, which can be combined with downstream rpm/torque converting devices in order to create gear steps, can be premounted by itself alone or else together with the hydrodynamic component as a structural unit and can be offered in this form. Both are combined into a single subassembly. However, it is also conceivable as well to create the lockup clutch from a gearbox arrangement disposed downstream of the hydrodynamic component, whereby, in this case, the hydrodynamic component is then combined with the overall gearbox by itself alone as an independently marketable structural unit. Accordingly, it is possible to dispose the lockup in the gearbox as well, that is, detached from the hydrodynamic component. The possibility of the lockup clutch offers the advantage here of performing the lockup function in the axial direction at any distance from the hydrodynamic component.

According to an especially advantageous embodiment, in accordance with FIG. 4, a free wheel F is arranged between the output of the starter element 2 and the input 26 of the lockup clutch 1. Arranged after it is a braking device that is coupled to the input 26. When the rpm of the secondary wheel 5 is too low compared to the input 26, the free wheel causes it to idle; that is, no power is transmitted from the secondary wheel 5 to the lockup clutch 1 and vice versa. When the rpm of the secondary wheel 5 is greater or equivalent, there exists a coupling via the free wheel and torque is transmitted. Here, the secondary wheel 5 can be braked for these purposes via the braking device to a speed that is less than the speed at the input 26 of the lockup clutch 1 all the way down to zero. This solution makes it possible, when the hydrodynamic clutch is filled, to achieve a braking of the drive engine and, furthermore, a holding function on hills, particularly a simple mechanical assurance against rolling backward. When power is supplied via the drive and torque reversal thereby ensues, the free wheel F is operated in the blocked direction and supports itself via the braking device during braking of the secondary wheel all the way down to zero on a positionally fixed element. In this function, the latter acts like a holding block for the vehicle.

### LIST OF REFERENCE NUMBERS

1 lockup arrangement
2 hydrodynamic component
3 hydrodynamic clutch
4 primary wheel
5 secondary wheel
6 working chamber
7 first back gear
8 second back gear
9 third back gear
10 back-gear shaft
11 spur gear set
12 spur gear set
13 spur gear set
14 pinion gear
15 pinion gear
16 spur gear
17 spur gear
18 first switchable clutch
19 spur gear
20 shaft
21 spur gear
22 braking device
23 second switchable clutch
24 third switchable clutch
25 subassembly
26 input
27 input
28 output
29 input
30 output
31 drive
32 first power branch
33 second power branch
34 spur gear

1-22. (canceled)

23. A lockup clutch for a hydrodynamic clutch that is free of a guide wheel, comprising:
a primary wheel and a secondary wheel which together define a working chamber that can be filled with operating fluid;
a first input linked to the secondary wheel;
a second input linked to the primary wheel;
an output;
a switchable clutch for selectively linking the first and second inputs to the output to form a first or a second power branch;
a first coupling between the second input and the output that is free of any rotationally fixed mechanical connection between the primary wheel and the secondary wheel in order to create the second power branch;
a second coupling between the first and second inputs and the output in the first and second power branches that comprises rpm/torque converting devices;
a first back gear and a second back gear having different gear ratios, wherein the gear ratio of the second back gear is changed by an amount of slip at a desired lockup in relation to the first back gear; and
a braking device that serves to fix the secondary wheel in place.

24. The lockup clutch according to claim 23, wherein the switchable clutch can be jointly used with the first and second power branches in the connections between the first and second inputs and the output.

25. The lockup clutch according to claim 23, wherein the first back gear is linked to the secondary wheel in a rotationally fixed manner, and wherein the second back gear is linked to the primary wheel in a rotationally fixed manner.

26. The lockup clutch according to claim 25 further comprising a back-gear shaft, wherein the switchable clutch is arranged between the first and second back gears for selectively coupling the first or second back gear to the back-gear shaft, and wherein the back-gear shaft is coupled to the output.

27. The lockup clutch according to claim 26 further comprising:
a first output of the first back gear; and
a second output of the second back gear, wherein the back-gear shaft is coupled to the first output, and wherein the second output forms the output.

28. The lockup clutch according to claim 26, wherein each of the rpm/torque converting devices further comprise the first and second back gears.

29. The lockup clutch according to claim 27, wherein the first and second outputs can be coupled to the output by a third back gear.

30. The lockup clutch according to claim 29, further comprising a second switchable clutch associated with the third back gear, wherein the second switchable clutch selectively links the third back gear to the back-gear shaft.

31. The lockup clutch according to claim 23, wherein the first and second back gears are arranged coaxially and parallel to each other.

32. The lockup clutch according to claim 23, wherein the first and second back gears are designed as spur gear sets.

33. The lockup clutch according to claim 23, further comprising a third switchable clutch that directly links the second input to the output.

34. The lockup clutch according to claim 33, wherein the third switchable clutch is arranged between the second and third back gears and selectively links the second back gear to the third back gear in a rotationally fixed manner.

35. The lockup clutch according to claim 23, wherein the switchable clutch is designed as a positive locking, synchronously switchable coupling.

36. The lockup clutch according to claim 35, wherein the switchable clutch is designed as a claw clutch.

37. The lockup clutch according to claim 23, wherein the switchable clutch is designed as a force-activated clutch.

38. The lockup clutch according to claim 23, further comprising a free wheel arranged between the secondary wheel and the first input.

39. The lockup clutch according to claim 23, wherein the switchable clutch is associated separately with the first and second power branches.

40. A subassembly having a hydrodynamic component with a lockup clutch according to claim 23.
